(19) United States
(12) Patent Application Publication
(10) Pub. No.: US 2004/0056440 A1
(43) Pub. Date: Mar. 25, 2004

(54) Apparatus and method for supporting substantially planar bases

(76) Inventor: Marc H. Hathaway, Phoenix, AZ (US)

Correspondence Address: SULLIVAN LAW GROUP, Suite 1140, 1850 North Central Avenue, Phoenix, AZ, 85004-4586, US

(21) Appl. No.: 10/251,627

(22) Filed: Sep. 20, 2002

(51) Int. Cl. B62B 3/00

(52) U.S. Cl. 280/47.35

(57) ABSTRACT

An apparatus and method are provided for supporting a substantially planar base relative to a horizontal ground plane. The apparatus includes a housing member and a base support coupled to the housing member. The base support is disposed to form a substantially non-orthogonal angle with respect to the horizontal ground plane. The base support also is configured to receive the base.

### BACKGROUND OF THE INVENTION

1. Field of the Invention

The present invention pertains to the field of substantially planar bases, and in an especially preferred embodiment to substantially planar bases used for supporting drapes, curtains, walls, and the like.

2. Description of the Related Art

Bases comprising a substantially planar surface area are commonly employed in various arts for performing functions such as, for example, supporting, anchoring, weighting, and/or stabilizing objects. To perform these and other functions, the substantially planar bases are usually relatively heavy and possess a broad dimension. These physical characteristics, however, can make storage and transportation of the bases difficult.

Industry trade shows represent an example of an environment in which substantially planar bases are used. Drapes and curtains are commonly employed at trade shows to provide an attractive backdrop for an exhibit, while simultaneously creating a self-enclosed environment that prevents visitors from being distracted by competitors' exhibits. Drapes and curtains are commonly supported from a framework of poles or the like. Typically, the poles comprise upright poles, each extending from and removably coupled to a respective base. The upright poles may be either free standing or interconnected to one another via cross supports, such as horizontal poles or cross braces for providing additional stability. The drapes or curtains hung from the poles commonly extend to the floor and can be relatively heavy and bulky. The drapes or curtains impart relatively large loads on the upright poles.

The bases are designed to anchor the upright poles in their intended upright positions, thus preventing the loads imparted by the drapes or curtains from skewing or overturning the upright poles. Typical design criteria for the bases include a relatively heavy weight and broad structure. For example, it is not uncommon for bases to weigh on average about 35 pounds and to have dimensions of 18″×18″×1/4″.

In addition to providing structural stability, the base and poles preferably are portable. Many if not most trade shows last a relatively short duration, often less than a couple of weeks. The exhibitors are given little time to assemble their exhibits before commencement of the show and to dismantle and remove their exhibits at the end of the show. In order to facilitate the portability of the drape supports, the poles are commonly coupled to their respective bases in a removable fashion. For example, the base may be provided with a threaded hole in which a threaded portion of the pole is received. Alternatively, lock pins or the like may be used to couple the poles to their respective bases. Despite the ability to remove the poles from the bases, the relatively heavy weight and bulk of the bases can make their transportation onerous and laborious. Each base is typically transported between storage and a transport device, e.g., a truck, and between the transport device and the trade show floor. Transportation can be further contemplated when a large number of bases are to be transported and used.

Individually hand-carrying each base between the truck and either storage or a trade show floor can be an arduous and inefficient exercise. It has been proposed to use flatbed dollies and wheel carts to ease the amount of labor involved in this exercise. However, it is difficult to stack more than a few of the bases onto a dolly or wheel cart. Further, the stacking of bases can increase the risk of injury to the handler or to personnel in proximity to the transported bases. Once the supports are loaded onto the truck, the supports are removed from the dollies/carts for ensuring safe transportation. To prevent shifting or movement of the supports during transportation, the supports may be laid out on the floor of the truck, although this procedure is an inefficient use of space. Alternatively, the supports may be stacked against and clamped to the side of the truck, which by itself is a laborious and time-consuming task.

It has been proposed to overcome the above-described drawbacks by utilizing a two-wheel metal dolly, or a four-wheel wooden cart having a horizontal base and a plurality of vertical slats. Each of the cart's vertical slats is sized and configured to guide a respective support vertically into the slat and to retain the support vertically within the slat. However, loading and unloading of the bases into these slats is relatively difficult, especially for heavier bases. For example, a person removing the bases from the wooden cart bears the entire weight of the base by lifting the base straight up until it clears the slat.

### OBJECTS OF THE INVENTION

Accordingly, an object of the present invention is to provide apparatus and methods for supporting and optionally transporting a substantially planar base, and more preferably a plurality of substantially planar bases, in an efficient manner.

Another object of the invention according to certain aspects is to provide apparatus and methods for supporting and optionally transporting a substantially planar base, and more preferably a plurality of substantially planar bases, at a substantially non-orthogonal angle with respect to a horizontal ground plane.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, an apparatus is provided for supporting a substantially planar base relative to a horizontal ground plane. The apparatus according to this first aspect of the invention comprises a housing member and a base support coupled to the housing member. The base support is disposed to form a substantially non-orthogonal angle in a range of about 5 degrees to about 45 degrees with respect to the horizontal ground plane. The base support is configured to receive the substantially planar base.

The housing member optionally but preferably is configured with a parallelepiped section, and more preferably a rectangular prism or cubic section. The housing member is optionally but preferably comprised of a metallic material, such as a tubular metallic material.

In an especially preferred embodiment of this aspect of the present invention, the housing member comprises a back portion that is substantially planar. The housing member also optionally but preferably comprises a front portion that is substantially planar, and more preferably substantially parallel with the back portion. Preferably but optionally, the apparatus according to this aspect of the invention comprises at least one side portion that is substantially planar. The side portion(s) may connect the front and back portions to one another, and optionally but preferably is/are orthogonal to the front and back portions.

In another optional but preferred embodiment of this aspect of the invention, the housing member comprises a top portion and a handle fixedly coupled to the top portion and optionally extending away from the ground plane. According to a variation of this embodiment, the housing member comprises a substantially planar back portion that lies substantially in a back plane, and the handle is substantially parallel to the back plane. According to another variation of this embodiment, the housing member comprises a substantially parallel back portion that lies substantially in a back plane, and the handle is substantially coplanar with the back plane. According to yet another variation of this embodiment, the handle comprises a tubular metallic member fixedly coupled to the top portion. According to still another variation of this embodiment, the handle is metallic and comprises an angled metallic material, such as an angle iron. In still another variation of this embodiment, the apparatus further comprises a gusset fixedly coupled to the top portion and to the handle.

The apparatus preferably, yet optionally, comprises a means for moving the apparatus horizontally with respect to the ground plane. The moving means preferably comprises wheels, and more preferably comprises at least four wheels preferably situated rectangularly with respect to one another. The moving means may comprise pneumatic supports, such as air-filled tires.

In accordance with another preferred embodiment of this aspect of the invention, the base support of the apparatus comprises a member selected from the group consisting of a shelf, a support track, a rail, and an angled metallic portion, such as an angle iron. Preferably the apparatus comprises a plurality of base supports.

In optional but preferred embodiments of this aspect of the invention, the substantially non-orthogonal angle at which the base support is disposed relative to the horizontal ground plane is in a range from 5 degrees to 45 degrees, and more preferably a range from 5 degrees to 20 degrees.

The apparatus according to this aspect of the invention optionally but preferably further comprises a stop for retaining the substantially planar base on the base support. The apparatus of this aspect of the invention may further optionally comprise a storage tray.

In accordance with a second aspect of the invention, a method is provided for supporting a substantially planar base relative to a horizontal ground plane. The method of this aspect of the invention comprises disposing the base in a base support coupled to a housing member. The base support is disposed to form a substantially non-orthogonal angle in a range of about 5 degrees to about 45 degrees with respect to the horizontal ground plane. Optionally, the base support and housing member form or are part of an apparatus according to any of the embodiments and variations of the first aspect of the invention described above. Preferably the base disposition comprises disposing the base in a base support so that the substantially non-orthogonal angle is in a range from 5 degrees to 45 degrees, more preferably 5 degrees to 20 degrees. The base disposition step optionally further comprises stopping the base at a fully inserted position in the base support using a stop.

In accordance with a third aspect of the invention, a method is provided for transporting a substantially planar base relative to a horizontal ground plane. The method of this aspect of the invention comprises providing an apparatus comprising a base support coupled to a housing member having moving means. The base support is disposed to form a substantially non-orthogonal angle in a range of about 5 degrees to about 45 degrees with respect to the horizontal ground plane. The method further comprises disposing the substantially planar base in the base support, and moving the housing member and the base support via the moving means. Optionally, the base support and housing member form or are part of an apparatus according to any of the embodiments and variations of the first aspect of the invention described above. Preferably the base disposition step comprises disposing the base in a base support so that the substantially non-orthogonal angle is in a range from 5 degrees to 45 degrees, more preferably 5 degrees to 20 degrees, still more preferably about 10 degrees. The base disposition step optionally further comprises stopping the base at a fully inserted position in the base support using a stop. The moving means may comprise wheels, and preferably comprises at least four wheels, which may be situated rectangularly relative to one another. The moving means may also comprise pneumatic supports.

### BRIEF DESCRIPTION OF THE DRAWINGS

The accompanying drawings, which are incorporated in and constitute a part of the specification, illustrate a presently preferred embodiment(s) and method(s) of the invention and, together with the general description given above and the detailed description of the preferred embodiment(s) and method(s) given below, serve to explain the principles of the invention.

FIG. 1. is a perspective side view of an apparatus for supporting a substantially planar base according to a preferred embodiment of the present invention;

FIG. 2 is a perspective front view of the apparatus of FIG. 1;

FIG. 3 is a perspective rear view of the apparatus of FIG. 1; and

FIG. 4 is a top view of the apparatus of FIG. 1.

### DETAILED DESCRIPTION OF THE PREFERRED EMBODIMENTS AND METHODS

Reference will now be made in detail to the presently preferred embodiments and methods of the invention. It should be noted, however, that the invention in its broader aspects is not limited to the specific details, representative apparatus and methods, and illustrative examples described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” may include plural referents unless the context clearly dictates otherwise.

In accordance with one aspect of the invention, an apparatus is provided for supporting a substantially planar base relative to a horizontal ground plane. The substantially planar base may comprise, but is not necessarily limited to, a drape base for supporting drapes, curtains, walls, the like, etc.

As referred to herein, a substantially planar base may comprise a base member having a planar surface on which the base may be rested on a horizontal ground plane. Substantially planar base may alternatively comprise a base member having a planar surface component, such as a planar perimeter, on which the base may rested on the base supports of the present invention. By way of example and not necessarily limitation, a substantially planar base may comprise a base member having a concave surface with the planar outer perimeter. Another example of a substantially planar base is a base member having a planar bottom and an opposite convex top facing upward. The phrase horizontal ground plane is used herein for reference purposes, and generally refers to an imaginary horizontal plane at ground level.

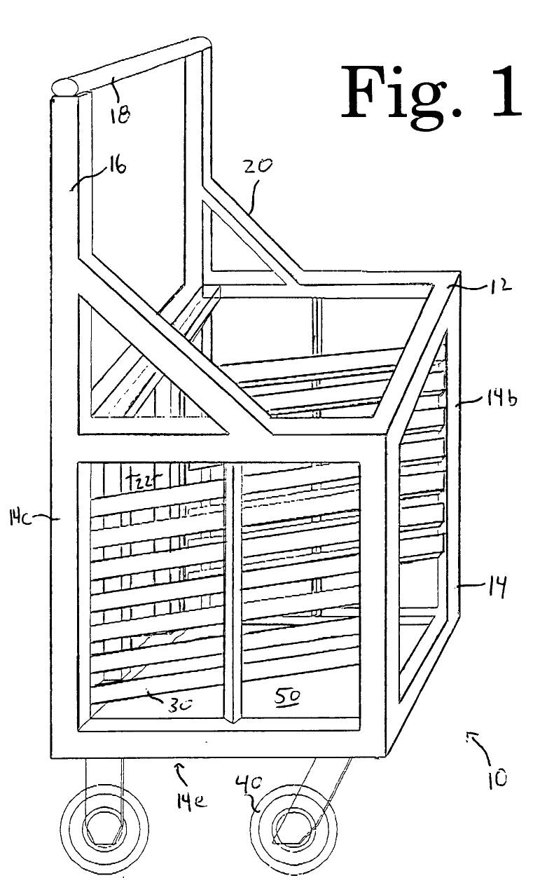

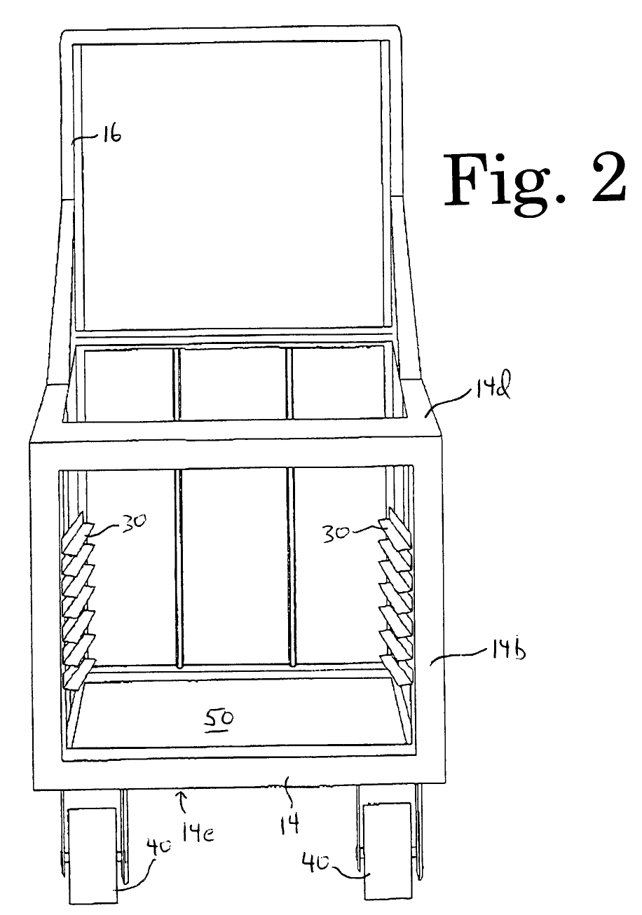

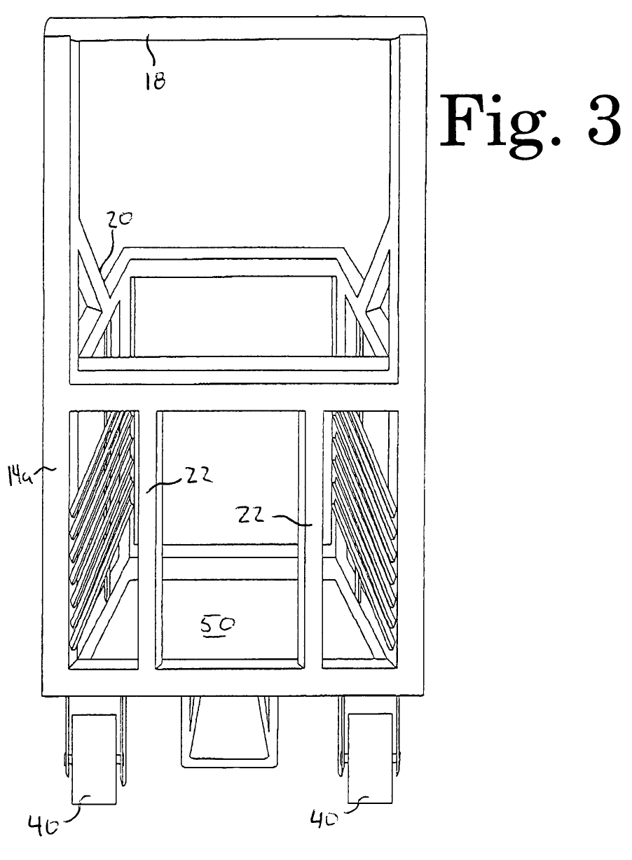

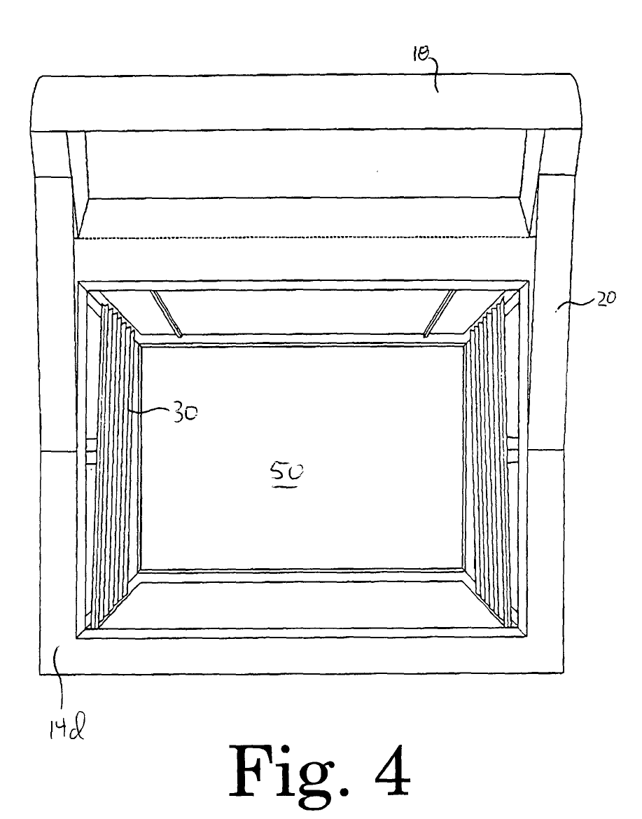

The apparatus of this aspect of the invention comprises a housing member. According to a presently preferred embodiment illustrated in FIGS. 1-4, there is shown an apparatus generally designated by reference numeral 10 comprising housing member 12 constructed from a plurality of beams. Preferably, the beams are comprised of metal, and more preferably the beams are comprised of hollow metallic tubes having a polygonal cross section. Exemplary metals from which the housing member 12 may be made include steel. The beams may be interconnected with one another by known techniques, including, for example, welding, fastener, bolting, etc. It is to be understood, however, that the housing member 12 may be comprised of, exclusively or in part, non-metallic materials. The walls of the housing member 12 may also be comprised of, for example, sheet metal or the like, as an alternative to or in addition to the metallic beams.

In a preferred embodiment of this aspect of the invention, the housing member is configured with a parallelepiped section or region, and more preferably a cubic or rectangular prism section or region. As shown in the drawings, the housing member 12 of this preferred embodiment comprises a lower section 14 and an upper section 16. The lower section 14 is shaped as a parallelepiped, and more particularly is illustrated in the drawings as being a cube. The lower section 14 comprises a substantially planar back portion 14a, a substantially planar front portion 14b, and substantially planar side portions 14c connecting the back and front portions 14a and 14b to one another. The back and front portions 14a and 14b are orthogonal to the side portions 14c. The back portion 14a, the front portion 14b, and the side portions 14c are each orthogonal to the horizontal ground plane. Top portion 14d and bottom portion 14e are both arranged parallel to the horizontal ground plane.

In the presently preferred embodiment of this aspect of the invention, the upper section 16 of the housing member 12 is fixedly coupled to the top portion 14d of the lower section 14 of the housing member 12. The upper section 16 comprises a handle 18 and a gusset 20. The handle 19 extends away from the ground plane. In a preferred embodiment, the upper handle 18 is substantially parallel to and coplanar with the substantially planar back portion 14a. Although not shown, the handle 18 may be parallel to but not coplanar with the back portion 14a. The gusset 20 is fixedly coupled between the top portion 14d and the handle 18.

In the illustrated embodiment, the lower section 14 of the housing member 12 further comprises a stop 22 situated in and coplanar with the back portion 14a. The stop 22 is configured as a vertical bar extending the length of the back portion 14a. The stop 22 may undertake a different configuration, position, and/or orientation. For example, the stop may extend diagonally along the back portion 14a or may comprise a plurality of stops arranged in a pattern or randomly, but constructed and arranged to perform the stopping function described below.

The apparatus of this aspect of the invention further comprises a base support coupled to the housing member. The base support is disposed to form a substantially non-orthogonal angle with respect to the horizontal ground plane. The base support is also configured to receive a base. According to presently preferred embodiments of this aspect of the invention, the base support may be configured to appear, for example and not necessarily by limitation, as a shelf, support tracks, rails, or the like. The base support may undertaken different configurations. Likely, the configuration of the base support will depend upon the shape and weight of the substantially planar base to be supported thereon.

Referring back to the embodiment illustrated in the drawings, the apparatus 10 of this presently preferred embodiment comprises a plurality of base supports 30. Each of the base supports 30 is illustrated as comprising opposing support tracks or rails respectively connected to side portions 14c. The opposing support tracks of each base support 30 are spaced apart from each other by a distance approximately equal to the width or length of a support. The base supports 30 have an open end contiguous with front portion 14b for receiving supports therein and a closed end contiguous with back portion 14a. The closed end of the base supports 30 includes the stop 22, e.g., for preventing a base received in the base support 30 from inadvertently falling out of the housing member 12 through the back portion 14a, such as during transport of the apparatus 10.

The opposing support tracks of each base support 30 are substantially coplanar with one another, but are arranged at a substantially non-orthogonal angle relative to the horizontal ground plane. As referred to herein, substantially non-orthogonal angle means an oblique angle between 1 and 89 degrees relative to the horizontal ground plane. Preferably, the base supports 30 are angled sufficiently steeply to prevent bases received therein from being inadvertently discharged through the open end of the base supports 30, i.e., through the front portion 14b, during transport of the apparatus 10. In furtherance of this object, the base supports 30 are preferably oriented at an oblique angle of at least about 5 degrees relative to the horizontal ground plane. Additionally, the base supports 30 are preferably oriented at an angle conducive for facilitating removal of bases through the open ends of the base supports 30. Preferably, the base supports 30 are oriented at an oblique angle not greater than about 45 degrees, and more preferably not greater than 20 degrees relative to the horizontal ground plane.

The apparatus 10 of the presently preferred embodiment of this aspect of the invention comprises seven base supports 30. The apparatus 10 may comprise more or less base supports 30, including as few as one base support. The base supports 30 are vertically arranged and substantially parallel relative to one another. The base supports 30 are spaced apart from one another by a distance greater than the thickness of the supports. By way of example, the apparatus may include 18 to 21 base supports.

The apparatus optionally but preferably comprises means for moving the apparatus horizontally with respect to the horizontal ground plane. The moving means may comprise, for example and not necessarily limitation, a member selected from the group consisting of wheels and tires (inflated or not inflated). In the embodiment illustrated in the drawings, the moving means are represented by a plurality of wheels 40 arranged rectangularly, i.e., as corners of a rectangle, with respect to one another. In order to improve the maneuverability of the apparatus, some or all of the moving means may be pivotally connected to the housing member. In the illustrated embodiment, the front two wheels are pivotal relative to the housing member 12. The wheels may optionally contain locks for preventing their forward and rearward rotation.

The apparatus also optionally but preferably comprises a receptacle, e.g., for holding retaining pins used for fastening the bases to the upright poles. In the embodiment illustrated in the drawings, the receptacle comprises a tray 50 coplanar with the bottom plane of the housing member 12.

In accordance with additional aspects of the invention, methods are provided for supporting a substantially planar base at a substantially non-orthogonal angle relative to a horizontal ground plane and for transporting the substantially planar base. In the interests of brevity and convenience, but not necessarily by limitation, the methods will be described below with reference to the illustrated apparatus. The method of this aspect of the invention comprises providing an apparatus comprising a housing member and a base support coupled to each other. The base support is disposed to form a substantially non-orthogonal angle with respect to the horizontal ground plane. The method further comprises disposing the base in the base support.

In the presently preferred embodiment illustrated in the drawings, the apparatus 10 is designed for supporting a plurality of substantially planar bases. It is to be understood, however, that the methods of this invention equally apply to the storage and transportation of a single substantially planar base. In the illustrated embodiment each of the base supports 30 is provided with an open end, which is optionally coplanar with the front portion 14b. A base is inserted into the open end of the base support 30, and is preferably slid along the base support 30 until coming to rest against stop 22, which is preferably but optionally coplanar with the back portion 14a. The rails of each base support 30 retain at least one base thereon. The base supports 30 are angled relative to the horizontal ground plane by a sufficient degree to impede the bases from being accidentally removed or dislodged from their corresponding base supports 30 during transportation. At the same time, the base supports 30 are oriented at an oblique angle that facilitates removal of the bases from the base supports 30.

The method for transporting the substantially planar bases further comprises providing the housing member with moving means, and using the moving means to move the housing member and the base support along the ground. For example, practice of this method on the illustrated embodiment is facilitated by a plurality of wheels 40 or pneumatic tires, which represent the moving means in the illustrated embodiment. The wheels 40 are preferably arranged to define a parallelogram, more preferably a rectangle or square.

The detailed description of the preferred apparatus and methods of this invention has been made above in the context of drape bases. It is to be understood that the scope of the invention is not necessarily limited to apparatuses and methods for storing and transporting drape bases. Rather, the apparatus and methods according to aspects of this invention may be used for storing and transporting other types of substantially planar bases, as well as other types of substantially planar items.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. An apparatus for supporting a substantially planar base relative to a horizontal ground plane, the apparatus comprising:
a housing member; and
a base support coupled to the housing member, the base support being disposed to form a substantially non-orthogonal angle in a range of about 5 degrees to about 45 degrees with respect to the horizontal ground plane, and the base support being configured to receive the base.

2. An apparatus as recited in claim 1, wherein the housing member comprises a parallelepiped section.

3. An apparatus as recited in claim 1, wherein the housing member comprises a metallic material.

4. An apparatus as recited in claim 1, wherein the housing member comprises a tubular metallic material.

5. An apparatus as recited in claim 1, wherein the housing member comprises a back portion that is substantially planar.

6. An apparatus as recited in claim 1, wherein the housing member comprises a front portion that is substantially planar.

7. An apparatus as recited in claim 1, wherein the housing member comprises a side portion that is substantially planar.

8. An apparatus as recited in claim 1, wherein the housing member comprises:
a top portion; and
a handle fixedly coupled to the top portion.

9. An apparatus as recited in claim 8, wherein:
the housing member comprises a substantially planar back portion that lies substantially in a back plane; and
the handle is substantially parallel to the back plane.

10. An apparatus as recited in claim 8, wherein:
the housing member comprises a substantially planar back portion that lies substantially in a back plane; and
the handle is substantially coplanar with the back plane.

11. An apparatus as recited in claim 1, wherein the housing member comprises:
a top portion;
a handle fixedly coupled to the top portion and extending away from the ground plane; and
a gusset fixedly coupled to the top portion and to the handle.

12. An apparatus as recited in claim 1, wherein the housing member comprises means for moving the apparatus horizontally with respect to the ground plane.

13. An apparatus as recited in claim 1, wherein the housing member comprises wheels.

14. An apparatus as recited in claim 13, wherein the housing member comprises at least four of the wheels.

15. An apparatus as recited in claim 13, wherein the housing member comprises four of the wheels, and wherein the wheels are rectangularly disposed with respect to one another.

16. An apparatus as recited in claim 1, wherein the base support comprises a support track.

17. An apparatus as recited in claim 1, wherein the base support comprises an angled metallic portion.

18. An apparatus as recited in claim 1, wherein the apparatus comprises a plurality of base supports.

19. An apparatus as recited in claim 1, wherein the substantially non-orthogonal angle is in a range from 5 degrees to 45 degrees.

20. An apparatus as recited in claim 1, wherein the substantially non-orthogonal angle is in a range from 5 degrees and 20 degrees.

21. An apparatus as recited in claim 1, wherein the housing member has a back plane, and wherein the apparatus further comprises a stop position in the back plane.

22. An apparatus as recited in claim 1, further comprising a storage tray.

23. A method for supporting a substantially planar base relative to a horizontal ground plane, the method comprising disposing the base in a base support, the base support being coupled to a housing member, the base support being disposed to form a substantially non-orthogonal angle in a range of about 5 degrees to about 45 degrees with respect to the horizontal ground plane.

24. A method as recited in claim 23, wherein the base disposition comprises disposing the base in the base support so that the substantially non-orthogonal angle comprises between 5 degrees and 20 degrees.

25. A method as recited in claim 23, wherein the housing member comprises a stop, and wherein the base deposition further comprises stopping the base at a fully inserted position in the base support using the stop.

26. A method as recited in claim 23, wherein the support comprises a drape support.

27 A method for transporting a substantially planar base with respect to a horizontal ground plane, the method comprising:
disposing the base in a base support, the base support being coupled to a housing member, the base support being disposed to form a substantially non-orthogonal angle in a range of about 5 degrees to about 45 degrees with respect to the horizontal ground plane;
providing the housing member with moving means; and
moving the housing member and the base support along the ground using the moving means.

28. A method as recited in claim 27, wherein the base disposition comprises disposing the base in the base support so that the substantially non-orthogonal angle comprises between 5 degrees and 20 degrees.

29. A method as recited in claim 27, wherein the housing member comprises a stop, and wherein the base deposition further comprises stopping the base at a fully inserted position in the base support using the stop.

30. A method as recited in claim 27, wherein the support comprises a drape support.
